(19) United States
(12) Patent Application Publication
(10) Pub. No.: US 2020/0116546 A1
(43) Pub. Date: Apr. 16, 2020

(54) CORRECTION FACTORS FOR FLUID DISPENSES

(71) Applicant: HEWLETT-PACKARD DEVELOPMENT COMPANY, L.P., Spring, TX (US)

(72) Inventors: Jeffrey A. NIELSEN, Corvallis, OR (US); Christie DUDENHOEFER, Corvallis, OR (US); Debora J. THOMAS, Corvallis, OR (US); Michael J. DAY, Corvallis, OR (US); Kenneth WARD, Corvallis, OR (US); David H. OCHS, Corvallis, OR (US)

(21) Appl. No.: 16/603,965

(22) PCT Filed: Sep. 27, 2017
(86) PCT No.: PCT/US2017/053743

§ 371 Date: Oct. 9, 2019

(51) Int. Cl. G01F 25/00; B01L 3/02; G05B 19/042

(52) U.S. Cl. CPC G01F 25/0092; B01L 3/0241; G05B 19/042; G05B 2219/23399; B01L 2200/143; G05B 2219/23258; B01L 2200/061

(57) ABSTRACT

In example implementations, a method is provided. The method may be executed by a processor of a fluid dispensing apparatus. The method includes storing a correction factor for an unqualified fluid. A request to dispense the unqualified fluid is received. A dispense parameter is adjusted in accordance with the correction factor. Then, the unqualified fluid is dispensed in accordance with the dispense parameter that is adjusted.

### BACKGROUND

Laboratories often run experiments using various different liquids to obtain different types of experimental data. The experiments may use fluid dispensers that dispense fluid onto surfaces, such as a microplate or an experimental surface to grow bio matter, to perform the various different experiments. The fluid dispensers may dispense fluids onto the selected surface. The fluids may then react with fluids on the surface.

### BRIEF DESCRIPTION OF THE DRAWINGS

FIG. 1 is a block diagram of an example apparatus of the present disclosure;

FIG. 2 illustrates an example screenshot of a graphical user interface (GUI) of the present disclosure;

FIG. 3 is a flow chart of an example method for dispensing a fluid based on a correction factor; and

FIG. 4 is a block diagram of an example non-transitory computer readable storage medium storing instructions executed by a processor.

### DETAILED DESCRIPTION

Examples described herein provide an apparatus and a method for applying a correction factor for dispensing a fluid. Different types of liquids may have different properties and/or characteristics and may be dispensed differently out of the same nozzle of the fluid dispenser. Thus, different fluids may be dispensed at different volumetric rates from the same sized nozzle of the fluid dispenser. In other words, for a same sized nozzle that is open for the same amount of time, two different fluids may dispense at different volumetric rates.

Currently, fluid dispensers may have qualified fluids. The characteristics of the qualified fluids may be known and stored in the fluid dispenser. As a result, the fluid dispenser may know precisely the optimal dispensing parameters to dispense a desired volume of a qualified fluid.

However, different customers may want to dispense different fluids. As a result, not all fluids may be qualified for the fluid dispenser. Current fluid dispensers may not accurately dispense a desired volume of unqualified fluids.

Examples described herein provide an apparatus or fluid dispenser that allows correction factors of unqualified fluids to be stored in memory. The unqualified fluids may then be dispensed accurately by the fluid dispensing apparatus by applying the correction factors to the fluid dispenser when the unqualified fluid is being dispensed. As a result, the present disclosure provides additional flexibility to customers who would like to use the fluid dispenser to dispense additional different types of unqualified fluids for their experiments.

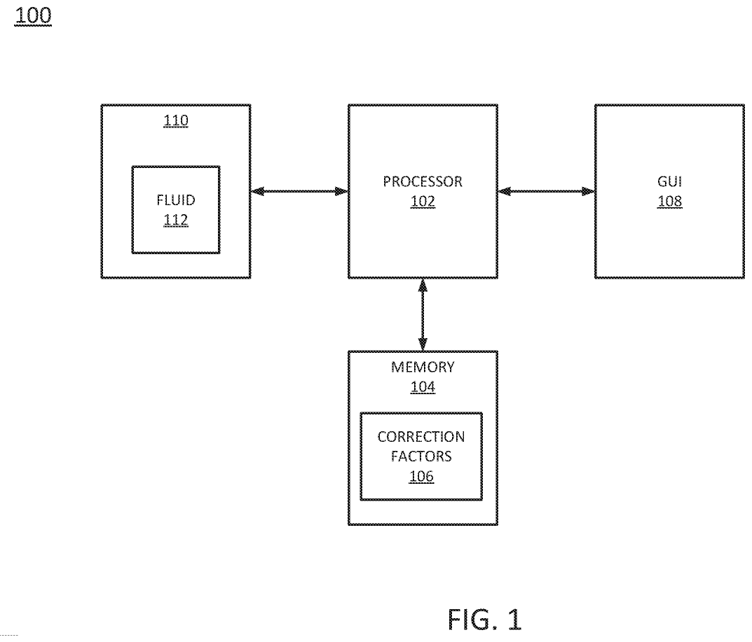

FIG. 1 illustrates a block diagram of a fluid dispensing apparatus 100. The fluid dispensing apparatus 100 may include a processor 102, a memory 104, a graphical user interface (GUI) 108 and a fluid dispenser 110. It should be noted that FIG. 1 is simplified for ease of explanation. The fluid dispensing apparatus 100 may include additional components not shown (e.g., a cassette, a platform to hold a surface that the fluids are dispensed onto, a housing, a graphics processor for the GUI 108, and the like).

In one example, the processor 102 may be communicatively coupled to the memory 104, the GUI 108 and the fluid dispenser 110. In one example, the fluid dispenser 110 may include a cassette that includes at least one dispense head. The dispense head may hold a fluid 112 and dispense the fluid via at least one nozzle. The fluid dispenser 110 may be a thermal inkjet printhead that has been modified to dispense fluids instead of ink used to print on paper. In another example, the fluid dispenser 110 may be a digital pipette system, an acoustic dispensing system, a pressure based dispensing system, a metering fluid dispense system, or any other type of fluid dispenser.

In one example, the fluid 112 may be the same fluid or may include a plurality of different fluids. For example, for a plurality of dispense heads, each dispense head of the fluid dispenser 110 may include a different fluid 112 or the same fluid 112. Some of the fluids 112 may be pre-qualified. In other words, the fluid dispensing apparatus 100 may have stored in the memory 104 properties and characteristics associated with the pre-qualified fluids. As a result, the processor 102 may control the fluid dispenser 110 precisely to dispense an accurate volume of the pre-qualified fluids.

However, as noted above, the some fluids 112 may be unqualified. In other words, the customer may want to dispense unqualified fluids that have properties or characteristics that are not stored in the memory 104. As a result, if the processor 102 were to try to dispense the unqualified fluids, an incorrect volume of the unqualified fluids may be dispensed. This may lead to inaccurate results in an experiment.

In one example, a user may provide correction factors 106 that are stored in the memory 104. The memory 104 may be a local hard disk drive, a read access memory (RAM), an external storage device (e.g., a universal serial bus (USB) memory device), and the like. The correction factors 106 may be provided by a user via the GUI 108.

The correction factors 106 may be obtained by comparing the properties of the unqualified fluid to the properties of a qualified fluid. For example, a user or a technician may run a dispense protocol with a known or qualified fluid and run the same dispense protocol with the unqualified fluid. The dispense protocol may be run with the fluid dispensing apparatus 100. Data may be collected from the dispensing of both the qualified fluid and the unqualified fluid.

The data may provide information that can be used to calculate the correction factors 106. In one example, the user may calculate the correction factors 106 using a ratio of the dispensed volume between the qualified fluid and the unqualified fluid (e.g., how much volume of the qualified fluid was dispensed and how much volume of the unqualified fluid was dispensed using the same dispense head, under the same conditions, for the same amount of time, and for the same dispense protocol) and properties that are known of the unqualified fluid (e.g., a viscosity, an evaporation rate, a concentration, and the like, of the unqualified fluid).

The correction factors 106 may then be entered via the GUI 108 and stored in the memory 104. The GUI 108 may be a touch screen interface or may be a non-touch screen GUI that uses a keyboard and mouse to provide input. The processor 102 may then apply the correction factors 106 during dispensing of the unqualified fluid during a dispensing protocol for the unqualified fluid.

The correction factors 106 may change a diameter of the nozzle used to dispense the unqualified fluid, change an amount of time the nozzle of the fluid dispenser is opened, change a number of drops of the unqualified fluid that the nozzle dispenses, change a number of nozzle that are used to dispense the unqualified fluid, and the like.

In another example, the user may enter the data that is collected in the GUI 108. The processor 102 may receive the data comparing the dispensing of the qualified fluid and the unqualified fluid and automatically calculate the correction factors 106. The correction factors 106 may then be stored in the memory 104.

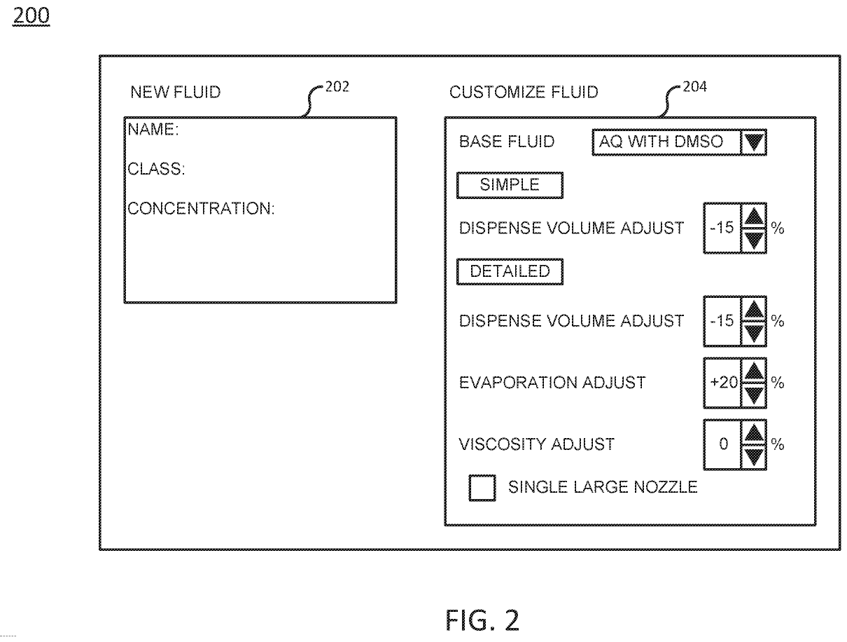

FIG. 2 illustrates an example screenshot 200 of the GUI 108. It should be noted that the arrangement and appearance of the GUI 108 may vary and that one example is illustrated in FIG. 2. For example, the GUI 108 may include different tabs that allow simple information or detailed information to display at different times, additional input buttons, and the like.

In one example, the GUI 108 may include an identification field 202 for the unqualified fluid. For example, the identification field 202 may allow the user to enter a name, a class, a concentration, and any other identification information, for the unqualified fluid.

The GUI 108 may also include a customization screen 204 that provides a plurality of different fluid parameter fields to receive respective values for the unqualified fluid to calculate the correction factors 106. The respective values may be relative values with respect to the qualified fluid (e.g., a percentage, or a ratio, relative to the values associated with the qualified fluid). The customization screen 204 may have a field to enter a base fluid (e.g., the qualified fluid that the unqualified fluid was compared to offline using the same dispense protocol).

In one example, the fluid parameter field may be a “simple” version that allows a user to provide a volume adjust percentage based on the dispensing ratio of the qualified fluid to the unqualified fluid described above. For example, if the unqualified fluid dispenses at a rate 15% less than the qualified fluid, the processor 102 may apply correction factors 106 that may include dispensing more drops of the unqualified fluid, using a different nozzle having a larger diameter opening, and the like.

In another example, the fluid parameter field may be a “detailed” version that allows a user to enter additional parameters associated with the unqualified fluid to calculate the correction factors 106. For example, the parameters or the properties associated with the unquailed fluid may include an additional adjustment based on an evaporation rate of the unqualified fluid, an additional adjustment based on a viscosity of the unqualified fluid, and the like. For example, if the unqualified fluid evaporates quickly, the volume adjustment may be more than the initial dispense volume adjustment of 15%. Moreover, if the unqualified fluid is less viscous (e.g., flows more quickly) than the qualified fluid, the volume adjustment may be less than the initial dispense volume adjustment of 15%.

In some examples, the GUI 108 may provide additional fields for selecting adjustments. For example, a check box may be provided to allow a user to use a single nozzle for the adjustments rather than using different nozzles for the adjustments.

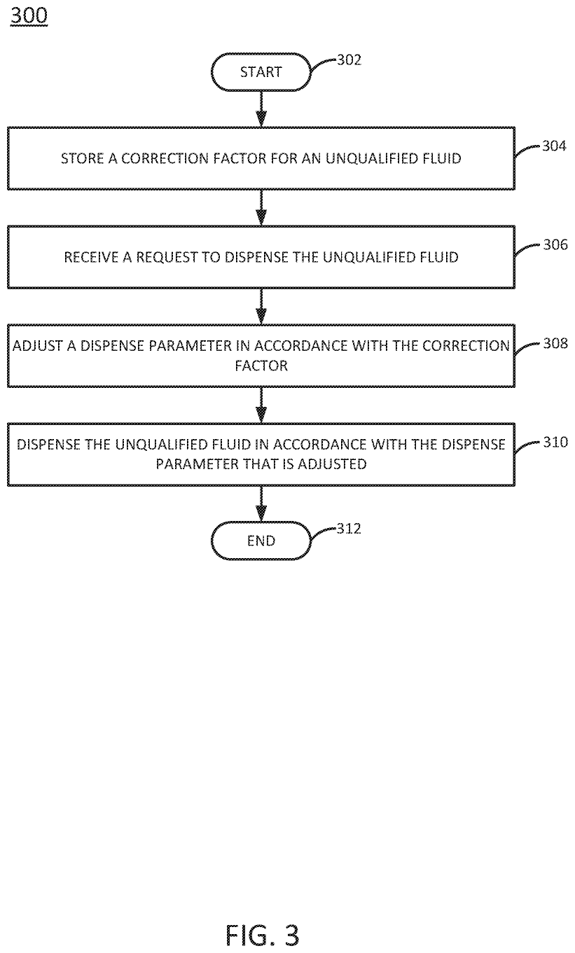

FIG. 3 illustrates a flow diagram of an example method 300 for dispensing a fluid based on a correction factor. In one example, the method 300 may be performed by the processor of the fluid dispensing apparatus 100 or the processor 102 of the fluid dispensing apparatus 100.

At block 302, the method 300 begins. At block 304, the method 300 stores a correction factor for an unqualified fluid. For example, the correction factor may be calculated based on data collected offline. The data may be a comparison of values for dispensing the unqualified fluid and dispensing a qualified fluid using the same dispensing protocol in the fluid dispensing apparatus.

In one example, the correction factor may be manually calculated by a user and entered via a GUI of the fluid dispensing apparatus. In another example, the data may be entered via the GUI of the fluid dispensing apparatus and the processor of the fluid dispensing apparatus may calculate the correction factor.

The correction factor may be used by the fluid dispensing apparatus to adjust a dispense parameter during dispensing of the unqualified fluid. The dispense parameter may include a dispense time (e.g., how long the unqualified fluid is dispensed), a size of the nozzle (e.g., a diameter of the nozzle opening) used to dispense the unqualified fluid, a frequency of dispensing, a number of dispensing nozzles that are used to dispense the unqualified fluid, a number of drops dispensed, and the like.

In one example, the correction factor may be applied to dynamically change the dispense parameter at different times, or different correction factors may be applied at different times for the unqualified fluid. For example, the correction factor may be based on an evaporation rate of the unqualified fluid. As a result, the correction factor may initially adjust a dispense parameter to provide more volume of the unqualified fluid by 20%, but then gradually adjust the dispense parameter to increase the volume of the unqualified fluid that is dispensed by 30% over time as the evaporation rate causes some of the unqualified fluid to evaporate during the dispense time.

The correction factor may be stored in a memory of the fluid dispensing apparatus. As a result, when a request to dispense the unqualified fluid is received, the fluid dispensing apparatus may use the stored correction factor. The stored correction factor may be used to dispense an accurate volume of the unqualified fluid during execution of a dispensing protocol that calls for the unqualified fluid.

At block 306, the method 300 receives a request to dispense the unqualified fluid. For example, after the correction factor is stored, a dispense protocol may be loaded and executed that uses the unqualified fluid. In one example, if a correction factor for the unqualified fluid is not stored in memory, the fluid dispensing apparatus may display an error message. In addition, the fluid dispensing apparatus may automatically display a prompt to enter information and data for the unqualified fluid (e.g., the screenshot 200 of FIG. 2) such that the correction factors can be calculated.

At block 308, the method 300 adjusts a dispense parameter in accordance with the correction factor. For example, the correction factor may change the dispense parameter for an amount of time the unqualified fluid is dispensed, a size of nozzle used to dispense the unqualified fluid, and the like. The dispense parameter may be adjusted by the processor of the fluid dispensing apparatus. In one example, the dispense protocol may be modified to include the adjusted dispense parameters that are based on the correction factors.

At block 310, the method 300 dispenses the unqualified fluid in accordance with the dispense parameter that is adjusted. As a result, an accurate volume of the unqualified fluid may be dispensed onto a surface (e.g., a well of a microplate, a layer of a bio-mass being grown on an experimental surface, and the like). At block 312, the method 300 ends.

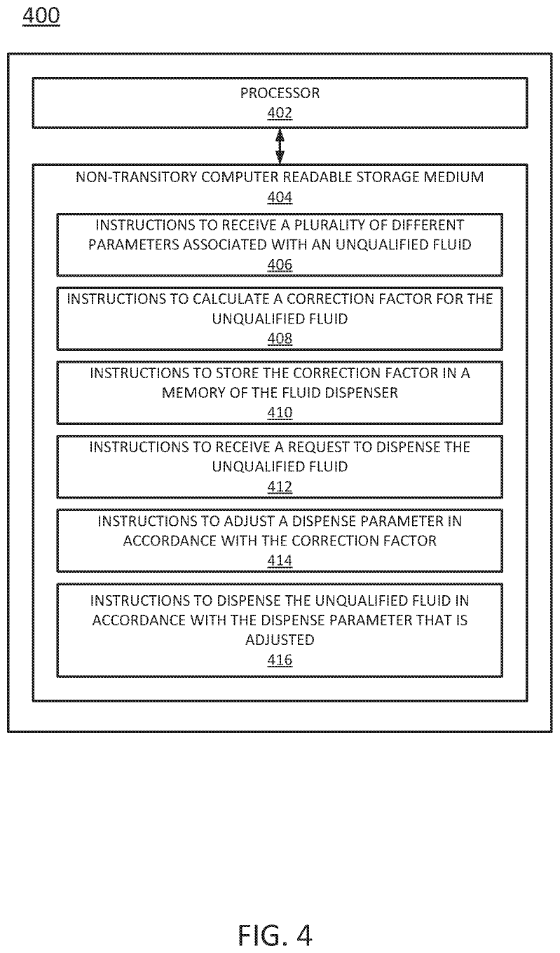

FIG. 4 illustrates an example of an apparatus 400, In one example, the apparatus 400 may be the fluid dispensing apparatus 100. In one example, the apparatus 400 may include a processor 402 and a non-transitory computer readable storage medium 404. The non-transitory computer readable storage medium 404 may include instructions 406, 408, 410, 412, 414 and 416 that when executed by the processor 402, cause the processor 402 to perform various functions.

The instructions 406 may include instructions to receive a plurality of different parameters associated with an unqualified fluid. For example, a user may run the same dispense protocol on a qualified fluid and an unqualified fluid to collect data. The data may include information related to how much volume of the unqualified fluid is dispensed relative to the volume of the qualified fluid that is dispensed. The parameters may also include properties associated with the unqualified fluid such as an evaporation rate, a viscosity, and the like.

The different parameters may be received via a GUI. The GUI may include different fields for the user to enter the values. The values may be values that are relative to the value of the qualified fluid (e.g., a percentage or a ratio).

The instructions 408 may include instructions to calculate a correction factor for the unqualified fluid. The processor of the fluid dispensing apparatus may automatically calculate the correction factors based on the received parameters. The correction factor may be value (e.g., a percentage or a ratio) that can be used to adjust a dispense parameter. For example, if the unqualified fluid has a correction factor of −15%, then the dispense parameter of dispense time may be adjusted to be 15% less than the dispense time for the qualified fluid that was used for comparison.

The instructions 410 may include instructions to store the correction factor in a memory of the fluid dispenser. The correction factor may be stored in a local hard disk drive, RAM, external USB drive, and the like. The processor may access the memory to obtain the correction factor when subsequent dispense requests for the unqualified fluid are received.

The instructions 412 may include instructions to receive a request to dispense the unqualified fluid. For example, a dispense protocol that uses the unqualified fluid may be loaded and executed by the fluid dispensing apparatus.

The instructions 414 may include instructions to adjust a dispense parameter in accordance with the correction factor. For example, the processor of the fluid dispensing apparatus may adjust the dispense parameter to dispense an accurate volume of the unqualified fluid. In one example, more than one dispense parameter may be adjusted to dispense the unqualified fluid. For example, the dispense parameter may include a dispense time (e.g., how long the unqualified fluid is dispensed), a size of the nozzle (e.g., a diameter of the nozzle opening) used to dispense the unqualified fluid, a frequency of dispensing, a number of dispensing nozzles or digital pipettes that are used to dispense the unqualified fluid, a number of drops dispensed, or any combination thereof.

The instructions 416 may include instructions to dispense the unqualified fluid in accordance with the dispense parameter that is adjusted. As a result, an accurate volume of the unqualified fluid may be dispensed onto a surface (e.g., a well of a microplate, a layer of a bio-mass being grown on an experimental surface, and the like).

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A method, comprising:
storing, by a processor of a fluid dispenser, a correction factor for an unqualified fluid;
receiving, by the processor, a request to dispense the unqualified fluid;
adjusting, by the processor, a dispense parameter in accordance with the correction factor; and
dispensing, by the processor, the unqualified fluid in accordance with the dispense parameter that is adjusted.

2. The method of claim 1, wherein the correction factor is calculated based on a comparison of dispensing the unqualified fluid to dispensing of a qualified fluid.

3. The method of claim 1, wherein the dispense parameter comprises a number of drops.

4. The method of claim 1, wherein the dispense parameter comprises a diameter of a dispensing nozzle.

5. The method of claim 1, wherein the dispense parameter comprises a number of dispensing nozzles that is used to dispense the unqualified fluid.

6. The method of claim 1, wherein the dispense parameter comprises a frequency of dispensing.

7. An apparatus, comprising:
a graphical user interface (GUI) that receives a correction factor for an unqualified fluid;
a fluid dispensing system that dispense the unqualified fluid in accordance with the correction factor;
a memory to store the correction factor; and
a processor in communication with the GUI, the fluid dispensing system, and the memory, wherein the processor adjusts a dispense parameter in accordance with the correction factor stored in the memory when a request to dispense the unqualified fluid is received.

8. The apparatus of claim 7, wherein the GUI comprises an identification field for the unqualified fluid.

9. The apparatus of claim 7, wherein the GUI comprises a plurality of different fluid parameter fields to receive respective values for the unqualified fluid to calculate the correction factor.

10. The apparatus of claim 7, wherein the request to dispense the unqualified fluid is received via a dispense protocol that is loaded into the memory and executed by the memory.

11. A non-transitory computer readable storage medium encoded with instructions executable by a processor of image capturing device, the non-transitory computer-readable storage medium comprising:
instructions to receive a plurality of different parameters associated with an unqualified fluid;
instructions to calculate a correction factor for the unqualified fluid;
instructions to store the correction factor in a memory of the fluid dispenser;
instructions to receive a request to dispense the unqualified fluid;
instructions to adjust a dispense parameter in accordance with the correction factor; and
instructions to dispense the unqualified fluid in accordance with the dispense parameter that is adjusted.

12. The non-transitory computer readable storage medium of claim 11, wherein respective values of each one of the plurality of different parameters is a relative value with respect to a qualified fluid.

13. The non-transitory computer readable storage medium of claim 11, wherein the plurality of different parameters is received via a graphical user interface (GUI).

14. The non-transitory computer readable storage medium of claim 11, wherein the dispense parameter comprises a number of drops.

15. The non-transitory computer readable storage medium of claim 11, wherein the dispense parameter comprises a diameter of a dispensing nozzle.
